(19) United States
(12) Patent Application Publication
(10) Pub. No.: US 2024/0091689 A1
(43) Pub. Date: Mar. 21, 2024

(54) FILTER ELEMENT FOR FLUID FILTRATION

(71) Applicant: UNIVERSITY COLLEGE CARDIFF CONSULTANTS LIMITED, Cardiff, South Glamorgan (GB)

(72) Inventors: Henry Alexander BLAND, Cardiff, South Glamorgan (GB); Soumen MANDAL, Cardiff, South Glamorgan (GB); Oliver Aneurin WILLIAMS, Cardiff, South Glamorgan (GB)

(21) Appl. No.: 17/768,206

(22) PCT Filed: Nov. 18, 2020
(86) PCT No.: PCT/GB2020/052937

§ 371 Date: Apr. 11, 2022

(30) Foreign Application Priority Data
Nov. 18, 2019 (GB) 1916744.4
Jul. 22, 2020 (GB) 2011305.6

(51) Int. Cl. B01D 39/20; B01D 39/16

(52) U.S. Cl. CPC B01D 39/2072; B01D 39/1692; B01D 2239/0258; B01D 2239/10; B01D 2239/1241

(57) ABSTRACT

A filter element for filtering a fluid is described. The filter element comprises diamond particles fixed to a filter substrate. Also described is a method for the manufacture of the filter element and a filtration device comprising the filter element.

### FIELD OF THE INVENTION

The invention relates to a filter element comprising diamond particles. The invention also relates to a method for manufacturing the filter element and to uses of the filter element. The invention further relates to a filtration device comprising the filter element.

### BACKGROUND

A growing population and an ever-changing environment have placed extreme pressures on the human race, not least its demand for clean drinking water. Whilst this has driven extensive research towards the treatment of waste and fouled water, removal of contaminants at the nanoscale has remained particularly problematic. Several technologies that include nanofiltration and reverse osmosis, processes in which liquid is forced through a filter element composed of a polymeric or ceramic membrane with pore sizes smaller than that of the target contaminant, suffer from high operating costs, low flow rates, and a high susceptibility to fouling. UV disinfection is a well proven method by which living contaminants can be targeted. However, its effectiveness often fluctuates between pathogen species, and must be used in combination with other disinfectants, such as chlorine. Alongside these complications, the vast majority of water treatment methods require some electrical input. For point-of-use technologies applicable to, for example, disaster relief, the aforementioned drawbacks lead to obvious logistical complications.

Depth filtration based on a charged ceramic is a potentially advantageous approach for nanoscale filtration because comparatively greater flow rates can be achieved, and costs are lower for both manufacture and operation. The technique involves passing water through a ceramic filter element that has been coated with a positively charged material. Contaminants are adsorbed onto the filter surface regardless of size, under the influence of van der Waals forces, electrostatic forces, or hydrophobic interactions. Polyelectrolytes, metallic hydroxides and salts, and zirconium and yttrium oxides have been developed as coatings for filter substrate. Whilst these coatings can provide a positively charged surface, they often suffer from poor adhesion to the base filter substrate and the coating can be washed into the water supply. They may also suffer from a low isoelectric point, a low overall zeta potential, and in some cases, the use of a toxic coating material.

### SUMMARY OF THE INVENTION

The invention provides a filter element. The filter element comprises diamond particles fixed to a filter substrate. The filter element is for filtering a fluid, such as a liquid or a gas. When the fluid is a gas, then typically the gas comprises a vapour.

It has been found that the filter element of the invention overcomes the problems mentioned above associated with filter elements in the prior art. The filter element of the invention can remove negatively charged contaminants present in fluids, such as liquids or vapours, that are difficult to remove using other filtration technologies. Such contaminants include viruses or negatively charged compounds, such as inks, dyes or paints.

The invention also provides a method of manufacturing a filter element. The method comprises: applying diamond particles to a surface of a filter substrate; and then fixing the diamond particles to the surface of the filter substrate.

The method can be used to manufacture a filter element in accordance with the invention. Thus, the invention also provides a filter element obtained or obtainable from the method.

A further aspect of the invention is a filtration device. The filtration device comprises a filter element of the invention. The filtration device is for filtering a fluid, such as a liquid or a gas, typically a gas comprising a vapour.

Another aspect of the invention relates to a method of filtering a liquid. The method comprises contacting the fluid, such as the liquid or the gas, with a filter element.

The invention also relates to uses of the filter element, or the filtration device comprising the filter element, in the filtration of a fluid, such as a liquid or gas.

### BRIEF DESCRIPTION OF THE DRAWINGS

The invention is further described hereinafter with reference to the accompanying drawings.

FIG. 1 is a photograph of an uncoated filter substrate (on the left) and a diamond coated filter element (on the right), in accordance with the invention.

FIG. 2 is an SEM image of the filter element.

FIG. 3 is a series of TEM images of an uncoated filter substrate (see a), b) and c)) and a filter element in accordance with the invention (see d), e) and f)).

FIGS. 4 and 5 are TGA curves. FIG. 4 is a TGA curve for hydrogen-terminated detonation nanodiamond (DND H-term). The shaded area indicates the temperature regime in which 5 nm diamond particles are oxidatively etched. FIG. 5 shows TGA curves for three filter elements, and an uncoated substrate. Each filter element was prepared by dip-coating with a different concentration of diamond colloid. The insert shows each TGA curve across the full temperature range.

FIG. 6 is a plot of diamond loaded onto the base filter element as a percentage of total filter mass, and as a function of dip-coating diamond colloid concentration.

FIG. 7 is a graph showing zeta potential measurements plotted as a function of pH, for the quartz substrate and for filter elements varying amounts of diamond nanoparticles.

FIG. 8 is a graph showing the zeta potential at pH 7 for each filter element, as a function of colloidal diamond concentration.

FIG. 9 shows a plot of the removal efficiency of Acid Black II dye as a function of total volume of dye solution filtered the UV-Vis results for a Nigrosin dye solution before and after filtration through a single filter of the invention, under ambient pressure.

FIGS. 10A to 10C are a series of histogram showing the retention performance of a 1350 μm stack of ND-QNF membranes for the virus-like bacteriophage MS2 (107 pfu/L) at three different pH values (pH 5, 7 and 9 respectively). Error bars are ±the standard deviation shown for three independent biological replicates. The dashed line shows the upper detection limit.

### DETAILED DESCRIPTION

The filter element is suitable for filtering a fluid, such as a liquid or a gas.

When the fluid is a liquid, it is preferred that the filter element is for filtering an aqueous liquid. The liquid may be water (e.g. contaminated water).

When the fluid is a gas, then typically the gas comprises a vapour.

The gas may be air or an exhaust emission. The exhaust emission may comprise, or consist of, a combustion by-product of a fossil fuel, such as from a petrol engine or a diesel engine. It is preferred that the gas is air.

Typically, the vapour is water vapour. It is preferred that the vapour is water vapour, particularly when the gas is air.

Advantageously, the filter element of the invention can avoid problems associated with filtration by size exclusion. The filter element of the invention does not require electrical input and allows a high throughput of liquid. Using the filter element of the invention, new low-cost filtration systems can be developed and manufactured.

The filter element of the invention is for use in the filtration of negatively charged contaminants from a fluid, such as from a liquid or from the vapour of a gas.

The filter element comprises diamond particles. Diamond particles have many advantageous properties, including extreme strength, high biocompatibility, and low reactivity. The diamond particles also provide a positively charged surface when in use. When the diamond particles are brought into contact with the fluid for filtration, they will electrostatically attract any negatively charged contaminants in the fluid, particularly from the liquid or from the vapour of the gas.

The diamond particles are used to filter contaminants from the fluid, such as from the liquid or from the vapour of a gas. The diamond particles filter contaminants from the fluid by electrostatic attraction (e.g. between the contaminants and the diamond particles).

The diamond particles typically have a mean particle diameter of ≤500 μm, such as ≤250 μm, preferably ≤100 μm, more preferably ≤50 μm, such as ≤10 μm, and still more preferably ≤5 μm.

The diamond particles may comprise, or consist essentially of, diamond nanoparticles. It may be preferable that the diamond particles are diamond nanoparticles.

Diamond nanoparticles, which have a small particle diameter, are preferred because they have a higher charge density when in use, which is better for electrostatically attracting negatively charged contaminants present in the fluid (e.g. the liquid or the vapour of a gas) for filtration.

The term “nanoparticles” as used herein in the context of “diamond nanoparticles” refers to particles having a diameter of less than 1 μm, such as less than 500 nm, preferably less than 100 nm, more preferably less than 50 mm.

There may be a size distribution of the diamond nanoparticles. For the avoidance of doubt, any reference to the nanoparticles having a diameter less than a certain numerical value (e.g. 500 nm, 100 nm or 50 nm) means that substantially all of the nanoparticles have a particle diameter below that value. The term “substantially all” as used in this context refers to at least 99.9%, preferably at least 99.99%, and more preferably 100%.

Typically, the diamond nanoparticles have a mean particle diameter of ≤500 nm, such as ≤250 nm, preferably ≤100 nm, more preferably ≤50 nm, such as ≤30 nm, and still more preferably ≤10 nm, such as from 1 nm to 10 nm (e.g. about 5 nm). Diamond nanoparticles having a smaller particle diameter are preferred because they have a higher charge density when in use, which is better for electrostatically attracting negatively charged contaminants present in the (e.g. the liquid or the vapour of a gas) for filtration.

The particle diameter as used herein refers to the primary particle diameter of the nanoparticles.

In principle, any conventional technique can be used to measure the particle diameter of the particles, particularly the nanoparticles. The particle diameters of the nanoparticles described herein refer to a volume-based measurement. Such measurements can be made by particle size analysers that use a laser diffraction/scattering method or dynamic light scattering. For example, the particle diameters of the diamond nanoparticles can be measured by dynamic light scattering (DLS) using a Malvern Zetasizer Nano ZS device in the backscatter configuration (173°). The mean particle diameter can be obtained by averaging 100 measuring processes, each process lasting for 30 seconds. A diffraction index of 2.4 for diamond may be used to convert the sizes of measured intensity/size distribution in the number of particles/size distribution.

The diamond particles are typically not aggregated or agglomerated.

The term “diamond” as used herein in the context of a “diamond particle” or a “diamond nanoparticle” refers to the allotropic form of elemental carbon in the solid phase. The diamond particles comprise, or consist essentially of, the diamond allotropic form of elemental carbon. When the diamond particles comprise the diamond allotropic form of elemental carbon, then typically greater than 50 wt % of the particles is diamond (e.g. the diamond allotropic form. It is preferred that at least 75 wt %, more preferably at least 90 wt %, still more preferably at least 95 wt % of the particles is diamond. For the avoidance of doubt, the term “diamond” may not embrace the allotrope diamondene.

The diamond nanoparticles may comprise, or consist essentially of, detonation nanodiamond (DND) and/or synthetic diamond. It is preferred that the diamond nanoparticles comprise, or consist essentially of, detonation nanodiamond (DND).

Methods for preparing diamond nanoparticles are known in the art. Processes have been developed for the commercial production of powders with highly dispersed diamond nanoparticles. These powders are known as detonation nanodiamond (DND) or ultra-dispersed diamond (UDD).

Diamond nanoparticles are typically present in soot yielded via the detonation method. Commercially available DND/UDD-powders typically show negative zeta-potentials.

When the diamond particles comprise, or consist essentially of, synthetic diamond, then the synthetic diamond may be high pressure, high temperature diamond (HPHT diamond) or chemical vapor deposition diamond (CVD diamond).

Typically, the diamond particles have a positively charged surface, preferably when in use, such as when the diamond particles are in contact with, or immersed in, the fluid (e.g. the liquid or the gas) for filtration.

In general, the diamond particles have a positive zeta-potential in deionised water at room temperature (i.e. 25° C.) at a pH from 3 to 7. Thus, the diamond particles have a zeta-potential greater than 0 mV at pH values of 3 to 7. It is preferred that the diamond particles have a zeta-potential ≥20 mV at a pH of 3 to 7, more preferably ≥30 mV at a pH of 3 to 7, and even more preferably ≥40 mV at a pH of 3 to 7.

Unless otherwise stated, any reference to a zeta-potential refers to a measurement performed in deionised water at room temperature (i.e. 25° C.).

Typically, the diamond particles have a zeta-potential less than 100 mV at pH values of 3 to 7. The diamond particles preferably have a zeta-potential ≤80 mV at a pH of 3 to 7, more preferably ≤70 mV at a pH of 3 to 7, and even more preferably ≤65 mV at a pH of 3 to 7.

Thus, at a pH of 3 to 7, the diamond particles have a zeta-potential (ζ) of 0<ζ<100 mV, preferably 20≤ζ≤80 mV, more preferably 30≤ζ≤70 mV, even more preferably 40≤ζ≤65 mV.

The zeta-potential is a measurement of the charge acquired by a particle in a medium. In principle, the zeta-potential can be measured using any conventional technique. The zeta-potential of the diamond particles was measured by laser Doppler electrophoresis with a Malvern Zetasizer Nano ZS device and by applying phase analysis light scattering (PALS). The measurements of the zeta-potential were calibrated via an aqueous suspension of polymer micro-spheres at a pH-value of 9.2 using the NIST1980 standard as a reference.

For the avoidance of doubt, the zeta-potential referred to herein is the mean zeta-potential.

The zeta-potential normally refers to a fluid, particularly a liquid. For a gas, a vapour (e.g. water vapour) or droplets of a liquid (e.g. water) are typically present within the gas. The zeta-potential can relate to the vapour or droplets of a liquid within the gas.

The diamond particles typically have surfaces terminated with hydrogen atoms. Thus, each diamond particle (e.g. of the plurality of diamond particles) has a surface that is hydrogen terminated. These diamond particles are referred to herein as hydrogen-terminated diamond particles. By terminating the diamond particle surfaces with hydrogen, high positive surface charges, such as +60 mV, can be obtained.

Methods for preparing hydrogen-terminated diamond particles are described in, for example, U.S. 2012/0315212 A1. The preparative method described in U.S. 2012/0315212 A1 allows excellent control over both the size and the zeta potential of the resulting diamond particles. The content of U.S. 2012/0315212 A1 is incorporated herein in its entirety.

The diamond particles are fixed to a filter substrate. The diamond particles are attached or secured to the filter substrate in a manner that prevents them from being washed or blown away from the filter substrate in use.

Generally, the filter substrate is a base material upon which the diamond particles are disposed or supported. The filter substrate may be any material provided it is possible to fix the diamond particles to a surface of the filter substrate. The filter substrate should not contaminate the fluid (e.g. the liquid or the gas) for filtration.

The filter substrate is typically permeable to the fluid (e.g. the liquid or the gas) for filtration. In principle, any filter substrate known in the art for the filtration of a fluid (e.g. the liquid or the gas), particularly water or water vapour in a gas, can be used in the invention.

The filter substrate may be a filter substrate for a surface filter, a filter substrate for a depth substrate or a filter substrate for a membrane filter. It is preferred that the filter substrate is for a surface filter or for a depth filter. More preferably, the filter substrate is for a depth filter.

The diamond particles may be partially embedded in the filter the substrate. Thus, the diamond particles are fixed to the filter substrate by being partially surrounded by the base material of the filter substrate. The diamond particles are partially embedded because they are not completely surrounded by the base material (e.g. a surface of the diamond particles can be brought into contact with the fluid (e.g. the liquid or the vapour of a gas)).

Typically, the diamond particles are disposed on a surface of the filter substrate. The diamond particles may be disposed as a layer on the surface of the filter substrate. The diamond particles, or the layer of the diamond particles, preferably provide an exterior or outermost surface of the filter element. This is to allow the fluid (e.g. the liquid or the vapour of a gas) for filtration to come into contact with the diamond particles. If the filter substrate is porous, then the outermost surface may be present within the pores of the filter substrate.

The diamond particles are, in general, uniformly distributed over the surface of the filter substrate.

The filter substrate may be porous or non-porous. It is preferred that the filter substrate is porous. When the filter substrate is porous, size exclusion filtration can be combined with the separation of negatively charged contaminants from the fluid (e.g. the liquid or the vapour of a gas) using the diamond particles.

The filter substrate may, for example, be an air filter substrate, such as a high-efficiency particulate air (HEPA) filter substrate.

In addition or as an alternative to the filter substrate being porous, the filter substrate may comprise, or consist essentially of, a fibrous material, a membrane or a granular material. It is preferred that the filter substrate comprises, or consists essentially of, a fibrous material.

Suitable fibrous materials include synthetic materials or ceramic materials. The synthetic material may include nylon, polyester, polyvinyl chloride, acrylic or rayon. The ceramic material may include a silicate glass, an aluminium silicate fibre, a borosilicate fibre or an alumina fibre. It is preferred that the fibrous material includes a ceramic fibre.

When the filter substrate is a fibrous material, then the filter substrate may be a woven material or a non-woven material.

Suitable membranes include a microfiltration membrane, an ultrafiltration membrane, a nanofiltration membrane or a reverse osmosis membrane. Such membranes are known in the art. It is preferred that the membrane is a microfiltration membrane or an ultrafiltration membrane.

The membrane may, for example, comprise a cellulose ester (e.g. a mixed cellulose ester), nylon, a polyester, a polyvinylchloride (PVC), a polypropylene, a polytetrafluoroethylene (PTFE), a polyethersulfone (PES), a polyvinylidene fluoride (PVDF) or a polycarbonate (e.g. track-etched polycarbonate).

The membrane may be a cross-flow membrane or a tangential-flow membrane.

Suitable granular materials include charcoal, garnet, magnetite, sand, perlite, cellulose or diatomaceous earth.

In general, the diamond particles may be fixed to the filter substrate by being bonded to the filter substrate.

A surface of the filter substrate typically comprises a carbide-forming compound. The carbide-forming compound is typically a material that can form a carbide compound with the diamond particles, such as at a temperature of 450° C. to 900° C., preferably 500° C. to 600° C.

The carbide-forming compound generally comprises an element having a lower electronegativity than the electronegativity of carbon.

The carbide-forming compound may, for example, comprise an alkali metal, an alkaline earth metal, scandium, yttrium, lanthanum, cerium, boron, aluminium, silicon, calcium or a transition metal, such as tungsten or iron. It is preferred that the carbide-forming compound comprises cerium, boron, aluminium or silicon, more preferably aluminium or silicon.

When the carbide-forming compound forms a carbide compound with the diamond particles, then resulting carbide may fix or bond the diamond particles to a surface of the filter substrate, such as by forming an interlayer therebetween. Thus, a base of each diamond particle may be bonded by the carbide to a surface of the filter substrate.

As will be explained further, the surface layer comprising the carbide-forming compound can be used to fix the diamond particles to the surface of the filter substrate through the formation of a carbide. The carbide is formed from a reaction between the carbon in the diamond particles and an element of the carbide-forming compound in the surface layer of the filter substrate. Unlike other materials for adsorbing contaminants, the diamond particles do not fall off the filter substrate.

The filter substrate typically has a surface layer comprising silicon. The diamond particles are disposed or supported on this surface layer.

In a first embodiment, the filter substrate comprises a carbide-forming compound. The body of the filter substrate comprises the carbide-forming compound. In other words, the filter substrate is made of a material comprising the carbide-forming compound.

In the first embodiment, the filter substrate has a surface layer comprising the carbide-forming compound. The surface layer is a surface of the body of the filter substrate.

In a second embodiment, the surface layer is a coating. Thus, a surface layer comprising a carbide-forming compound is applied as a coating onto a surface of a base substrate. The coated base substrate provides the filter substrate.

When the surface layer is a coating, then preferably the coating is fixed to a surface of the base substrate.

In general, including the first and second embodiments, the filter substrate and/or the surface layer thereof comprise, or consist essentially of, a carbide-forming compound. The carbide-forming compound may be selected from an oxide of silicon, an oxide of boron, an oxide of aluminium and an oxide of cerium, preferably an oxide of silicon and an oxide of aluminium, more preferably an oxide of silicon.

The carbide-forming compound may comprise, or consist essentially of, silica, a silicate, an aluminium silicate, alumina, ceria or a borosilicate. Preferably, the carbide-forming compound is an oxide of silicon, which preferably comprises, or consists essentially of, silica, silicate or an aluminium silicate, preferably silica. More preferably, the surface layer comprises glass or quartz, particularly quartz. It is preferred that the filter substrate comprises, or consists essentially of, glass fibres or quartz fibres, particularly quartz fibres.

In general, when the filter substrate comprises fibres, particularly glass fibres or quartz fibres, then typically the fibres have a thickness of 100 μm to 1500 μm, preferably 150 μm to 1000 μm, more preferably 200 μm to 750 μm, and still more preferably 250 μm to 500 μm.

Silicon-based filters are preferred due to their mechanical strength and chemical stability.

Typically, the filter substrate is stable at a temperature for forming a carbide to bond the diamond particles thereto.

The maximum operating temperature of the filter substrate may be >500° C., preferably ≥550° C., more preferably ≥600° C., such as ≥650° C., and even more preferably ≥750° C.

The filter substrate may optionally comprise a binder resin.

The filter element has a positively charged surface, when in use, such as when the filter element is in contact with, or immersed in, the fluid (e.g. the liquid or the gas) for filtration.

The filter element typically has a zeta-potential greater than 0 mV at pH values of 5 to 9. It is preferred that the filter element has a zeta-potential ≥10 mV at a pH of 5 to 9, more preferably ≥20 mV at a pH of 5 to 9, and even more preferably ≥30 mV at a pH of 5 to 9.

Typically, the filter element has a zeta-potential less than 100 mV at pH values of 5 to 9. The filter element preferably has a zeta-potential ≤80 mV at a pH of 5 to 9, more preferably ≤70 mV at a pH of 5 to 9, and even more preferably ≤65 mV at a pH of 5 to 9.

Thus, at a pH of 5 to 9, the filter element has a zeta-potential (ζ) of 0<ζ<100 mV, preferably 10≤ζ≤80 mV, more preferably 20≤ζ≤70 mV, even more preferably 30≤ζ≤65 mV.

The zeta-potential of the filter element can also be measured using any conventional technique. The zeta potential of filter element was determined from streaming potential measurements, using an electrokinetic analyser (SurPASS 3, Anton Paar Gmbh, Austria).

The filter element may comprise an amount of diamond particles of 0.01 to 10.0 wt %, preferably 0.1 to 7.5 wt %, more preferably 0.5 to 5 wt %.

The filter element preferably comprises an effective amount of diamond particles for filtration of contaminants from the fluid (e.g. the liquid or the vapour of a gas). The effective amount of diamond particles will depend on the surface area and composition of the filter substrate.

The zeta potential of the filter element may level off once the amount of diamond particles passes above a certain threshold value. It is believed that at this threshold value, the surface of the filter element is saturated with diamond particles. The inclusion of additional diamond particles has no effect on the electrostatic properties of filter element because the diamond particles are loaded on top of one another. Diamond particles block the electrostatic contribution to the zeta potential provided by any underlying diamond particles.

It is preferred that the loading of diamond particles provides a maximum positive zeta potential of the filter element at a pH of 5 to 9, preferably a pH of 7. As demonstrated in the examples, it is possible to determine this maximum by vary the loading of diamond particles and measuring the zeta potential of the resulting filter elements.

The invention also provides a method of manufacturing the filter element.

The method involves applying diamond particles to a surface of the filter substrate. The diamond particles that are applied to the surface of the filter substrate are the diamond particles in accordance with the invention as described herein.

The diamond particles may be applied to a surface of the filter substrate by coating a surface of the filter substrate with a liquid dispersion of the diamond particles, particularly the diamond nanoparticles.

The surface of the filter substrate may be coated with the liquid dispersion by any conventional technique. The filter substrate may be immersed in the liquid dispersion to coat a surface of the filter substrate with the liquid dispersion. The filter substrate may be soaked or dip-coated in the liquid dispersion, preferably the filter substrate is dip-coated in the liquid dispersion.

An advantage of using a liquid dispersion to apply the diamond particles to the filter substrate is that this process is cheap and convenient because it does not require the use expensive, specialised hardware that is needed for other techniques, such as CVD.

The liquid dispersion of the diamond particles, particularly diamond nanoparticles, is preferably a colloidal dispersion of the diamond particles, more preferably an aqueous colloidal dispersion of the diamond particles.

Typically, the liquid dispersion has a concentration of the diamond particles of 0.01 mg mL⁻¹ to 10.0 mg mL⁻¹, preferably 0.1 mg mL⁻¹ to 5.0 mg mL⁻¹.

After applying the diamond particles to a surface of the filter substrate, the filter substrate may be heated, particularly when a surface of the filter substrate is coated with a liquid dispersion of the diamond particles. The filter substrate may be heated to evaporate the liquid from the liquid dispersion (e.g. to produce dry diamond particles on the surface of the filter substrate).

The method involves fixing the diamond particles to the surface of the filter substrate. The diamond particles may be fixed to the surface of the filter substrate by any conventional technique.

It has been found that fixing the diamond particles to a surface of the filter substrate through the formation of a carbide bond is particularly advantageous.

The filter substrate preferably has a surface layer comprising a carbide-forming compound as described herein. Thus, the step of applying diamond particles to a surface of a filter substrate is a step of applying diamond particles to a surface layer of the filter substrate, wherein the surface layer comprises a carbide-forming compound, such as silicon. The body of the filter substrate may comprise a carbide-forming compound, as in the second embodiment. Alternatively, the surface layer comprising the carbide-forming compound may have been applied as a coating onto a surface of a base substrate, as in the second embodiment of the invention.

The filter substrate and/or the surface layer thereof comprise, or consist essentially of, a carbide-forming compound. The carbide-forming compound may be selected from an oxide of silicon, an oxide of boron, an oxide of aluminium and an oxide of cerium, preferably an oxide of silicon and an oxide of aluminium, more preferably an oxide of silicon.

The carbide-forming compound may comprise, or consist essentially of, silica, a silicate, an aluminium silicate, alumina, ceria or a borosilicate. Preferably, the carbide-forming compound is an oxide of silicon, which preferably comprises, or consists essentially of, silica, silicate or an aluminium silicate, preferably silica. More preferably, the surface layer comprises glass or quartz, particularly quartz. It is preferred that the filter substrate comprises, or consists essentially of, glass fibres or quartz fibres, particularly quartz fibres.

The method typically involves fixing the diamond particles to the surface layer of the filter substrate, wherein the surface layer comprises a carbide-forming compound. The diamond particles may be fixed to the surface layer of the filter substrate by heating the diamond particles on the surface layer of the filter substrate. The heating is to form a carbide bond (e.g. a silicon-carbide bond) between the diamond particles and the filter substrate.

The diamond particles on the surface layer of the filter substrate may be heated to a temperature suitable for the formation of a carbide. Normally, high temperatures of 1600° C. to 2500° C. would be needed to form a carbide, such as silicon carbide. This is problematic because degradation of the filter substrate may occur at such high temperatures.

When the diamond particles are diamond nanoparticles, then the diamond nanoparticles have a high surface area to volume ratio. It has surprisingly been found that the diamond nanoparticles allow the formation of a carbide, particularly silicon carbide, at much lower temperatures than would normally be expected.

The diamond nanoparticles may be fixed to the surface layer of the filter substrate by heating the diamond nanoparticles on the surface layer of the filter substrate to a temperature of 450° C. to 900° C., preferably 500° C. to 600° C.

In general, the heating may be performed for 0.5 to 24 hours, preferably 1 to 10 hours, more preferably 2 to 5 hours. The heating time will depend on the size of the filter substrate and the concentration of diamond particles on the surface of the filter.

The heating is typically performed under a vacuum, such as in an evacuated chamber, preferably at a pressure of ≤10⁻³ mbar, such as ≤10⁻⁴ mbar (e.g. 10⁻⁴ mbar to 10⁻⁷ mbar). Heating in this way ensures that there are no atmospheric gases to interfere with the reaction between the diamond particles and the carbide-forming compound present in the surface layer of the filter substrate. The term “vacuum” as used herein refers to a pressure that is below atmospheric pressure.

The diamond particles used in the method of manufacturing a filter element may be hydrogen-terminated diamond particles. Thus, any reference to the use of “diamond particles” in the method of manufacturing a filter element above includes the use of hydrogen-terminated diamond particles.

The method of manufacturing a filter element may include a step of preparing hydrogen-terminated diamond particles, particularly hydrogen-terminated diamond nanoparticles. This step is performed before the step of applying diamond particles to a surface of the filter substrate. Hydrogen-terminated diamond particles (including nanoparticles) may be prepared as described in U.S. 2012/0315212 A1.

Typically, the hydrogen-terminated diamond particles are prepared by heating diamond particles (e.g. detonation nanodiamond (DND) or ultra-dispersed diamond (UDD) in a gas atmosphere comprising at least 50% hydrogen gas. It is preferred that the gas atmosphere comprises at least 75%, such as at least 90%, more preferably at least 99%, even more preferably at least 99.9% hydrogen gas. The percentages refer to an amount by volume.

The diamond particles may be heated at 400° C. to 1000° C., preferably 400° C. to 600° C., and more preferably about 500° C.

The invention also provides a filtration device for filtering a fluid (e.g. a liquid or a gas). The filtration device comprises a filter element of the invention.

The filtration device may be used for the industrial filtration of a fluid (e.g. a liquid or a gas) or the filtration device may be for personal use, such as in areas where there is no clean drinking water or when providing disaster relief, or when used as a personal respirator. An advantage of the filtration device is that it does not require electrical power for its operation.

When the fluid is a gas, such as when the gas is air, then the filtration device may be a respirator (e.g. personal respirator, such as a personal respirator mask) or a component of an air purifying unit, a ventilator or an air conditioning unit. When the gas is an exhaust emission, then the filtration device may be an emissions control device for a vehicle (e.g. a catalytic convertor) or for industry.

In general, the filtration device may be for surface filtration, depth filtration or membrane filtration. It is preferred that the filtration device is for surface filtration or depth filtration, more preferably depth filtration.

Typically, the filtration device comprises a housing. The housing may comprise a filter element of the invention. The filter element is disposed within the housing.

The housing may comprise a plurality of filter elements. The plurality of filter elements may include at least one filter element of the invention and optionally a size exclusion filter element (e.g. a microfilter, a nanofilter or an ultrafilter) and/or a reverse-osmosis filter.

When the housing comprises a plurality of filter elements, then the filter elements may be arranged in series (e.g. in the flow direction of the fluid, particularly the flow direction of a liquid or a gas comprising a vapour). The filter element of the invention may be the final or end filter element in the series arrangement of the plurality of filter elements. This is to prevent the filter element from becoming blocked or fouled with contaminants.

The housing typically supports the filter element(s). Each filter element may be mounted within the housing within a holder. The holder may be detachable from the housing. This may facilitate the cleaning or the regeneration of the filter element, where necessary, at periodic intervals, or the replacement of a filter element.

In general, the housing includes an inlet for receiving the fluid and an outlet for exiting filtered fluid. The housing may define a flow path for delivering the fluid for filtration to the filter element and/or for delivering filtered fluid to the outlet.

The filtration device filters the unfiltered fluid entering the inlet of the housing.

The inlet is suitable for receiving an unfiltered fluid from a supply source.

The filtration device may further comprise a collection container for the filtered fluid when it is a liquid or for the filtered vapour when the fluid is a gas. The outlet may be suitable for directing exiting filtered fluid to the collection container.

The invention also provides a method of filtering a fluid, such as a liquid or a gas. The fluid is a contaminated fluid or an unfiltered fluid, such as a contaminated liquid or an unfiltered liquid. When the fluid is a gas, the vapour of the gas may be a contaminated vapour or an unfiltered vapour.

Any reference herein to a “contaminated fluid, liquid or vapour” or an “unfiltered fluid, liquid or vapour” in the context of the filter element of the invention refers to a fluid, liquid or vapour, respectively, that comprises a negatively charged contaminant or impurity, preferably a negatively charged contaminant or impurity having a size of up to 500 nm, more preferably 30 to 300 nm. The negatively charged contaminant or impurity may, for example, be a virus or a compound, such as a dye.

Typically, the fluid, such as the liquid or vapour, has a pH of less than or equal to 11. At a pH≤11, the filter element may have a positive charge.

The method involves contacting the fluid with a filter element of the invention. The step of contacting the fluid with the filter element is to filter the fluid. When the fluid is a liquid, then the contacting the liquid with the filter element is to filter (e.g. directly filter) the liquid. When the fluid is a gas, then the contacting the gas with the filter element is to filter the vapour of the gas. The way in which the contacting is performed depends on the type of filtration that is employed.

Typically, the step of contacting the fluid with the filter element is by passing the fluid (e.g. the liquid or the gas) through the filter element. The fluid may be passed through the filter element at atmospheric pressure. Alternatively, a pressure above atmospheric pressure may be applied to the fluid to push it through the filter element. In another alternative, a reduced pressure (e.g. a pressure below atmospheric pressure) may be applied to the filter element to draw the fluid through it.

The invention also relates to uses of the filter element, or the filtration device comprising the filter element, in the filtration of a fluid (e.g. the liquid or the vapour of a gas).

The filtration of the fluid may be to remove a negatively charged impurity from the fluid ((e.g. the liquid or the vapour of a gas), such as a virus, a dye, a metal anion, a pathogen (e.g. bacterium, fungus, protozoan or prion) and the like, preferably a virus, a dye or a metal anion, particularly a virus.

When the fluid is a gas, the contaminant or negatively charged impurity may be a virus or a pathogen, preferably a virus.

For the avoidance of doubt, the expression “consists essentially of” as used herein limits the scope of a feature to include the specified materials, and any other materials or steps that do not materially affect the basic and novel characteristics of that feature, such as, for example, minor impurities. The expression “consists essentially of” embraces the expression “consisting of”.

### EXAMPLES

The invention shall now be illustrated by the following non-limiting examples.

### Example 1

### Preparation of Colloidal Diamond Nanoparticles

Commercial detonation nanodiamond powder ‘Purified grade G01’, sourced from PlasmaChem Gmbh, was annealed in hydrogen gas (100 sccm, 10 mbar) at 500° C. The annealed powder was added to 500 mL deionised water, and dispersed via high power ultrasound, using the Sonics Vibra-cell VCX 500 at 200 W (3 s on 2 s off duty cycle), for 5 hours. The temperature was maintained below 20° C. The solution was allowed to settle for 24 hours before centrifuging for 90 minutes at 40000 g in a Sigma 3-30 KS centrifuge, to afford a monodisperse colloid of 5 nm hydrogen-terminated diamond nanoparticles. Colloidal concentrations of 0.2 mg mL⁻¹ and zeta potentials of +55 mV were obtained. Gentle heating from a heat block to evaporate water from the colloid allowed the desired concentrations of colloidal diamond nanoparticles to be prepared.

### Preparation of Filter Elements

A quartz fibre filter obtained from Merck & Co., Inc. was selected as the filter substrate. The filter substrate is a simple depth filter comprising a heat-treated binder free quartz fibre. The properties of the filter substrate are summarised in Table 1.

TABLE 1

| Filter type | Depth | |
|---|---|---|
| Material | Quartz fibre | |
| Maximum operating temperature | 950° | C. |
| Thickness | 430 | μm |

The filter substrate was immersed (dip-coated) in a pristine diamond nanoparticle colloid for 3 hours, in which time the diamond colloid permeated the filter by capillary action alone. The filters were removed from the diamond colloid and dried for 24 hours, under atmospheric conditions. The coated filters were heated to 500° C. for 4 hours, under a vacuum of 10⁻⁵ mbar, which fixed the diamond coating to the filter by formation of a silicon carbide interlayer between the diamond particles and the quartz filter. The loaded filters were cooled to room temperature over 24 hours and washed in a bath of deionised water to remove any unbound particles.

### Characterisation of Filter Elements

Scanning electron microscopy (SEM) and Transmission electron microscopy (TEM) were used to examine the morphology of the filters before and after diamond coating. SEM images were taken using a Raith e-line operating at 20 kV and a 10 mm working distance. TEM images were taken using a JEOL JEM-2100 operating at 200 kV. TEM samples were supported on a 3.05 mm copper grid.

Thermogravimetric analysis (TGA) was used to determine the extent of the diamond coating following dip-coating in various concentrations of colloidal nanodiamond. The measurements were carried out using a Perkin Elmer TGA4000 Thermogravimetric Analyser. Measurements were taken under an air atmosphere at 50mL min⁻¹, and the temperature was ramped between 30° C. and 900° C. at a heating rate of 5° C. min⁻¹.

The zeta potential of filter samples was determined from streaming potential measurements, using an electrokinetic analyser (SurPASS 3, Anton Paar Gmbh, Austria). The SurPASS system comprises two Ag/AgCl electrodes at either end of a streaming channel, and the streaming potential is determined by measuring the potential difference between the inlet and outlet electrode, as a function of the electrolyte pressure. Disks of 14 mm filter material were mounted across the streaming channel, between two perforated support disks, and the permeability was controlled by compression of the filter element. A 10⁻¹ M solution of KCl was used as the electrolyte solution, and the pressure was controlled between 600 and 200 mbar. In this arrangement, the electrolyte permeates the filter material, and the streaming potential of the internal filter material can be determined. The zeta potential is measured as a function of electrolyte pH; 0.1 M HCl and 0.02 M NaOH solutions were used to induce changes in electrolyte pH, using the SurPASS's inbuilt titration system. Four measurements were taken at each pH value, and an average was taken of the resulting data points.

### Morphology

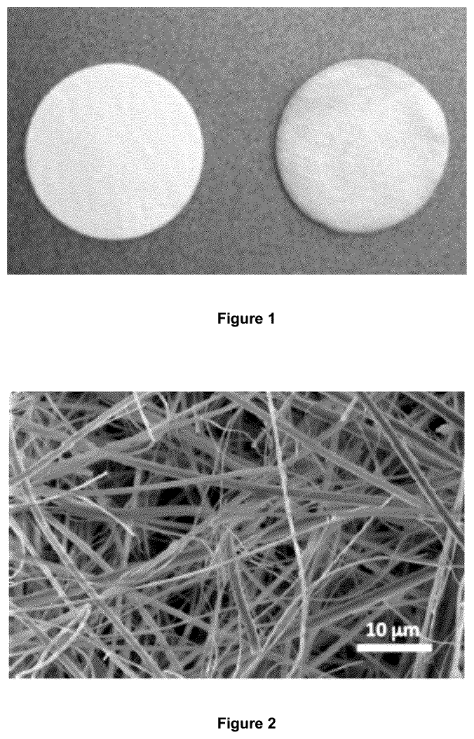

The filter element is shown to the right of FIG. 1. The filter substrate changes colour from white (shown to the left in FIG. 1) to yellow when dip-coated in a diamond nanoparticle colloid, and annealed at high temperatures. An example filter element, prepared by dip-coating in a 3.2 mg mL⁻¹ diamond colloid, is shown to the right of FIG. 1. The colour change becomes more distinct as the concentration of the diamond colloid increases, indicating that more diamond is loaded onto the filter substrate surface. The diamond loaded substrates are annealed under vacuum in order to fix the diamond to the surface, through the formation of a silicon carbide interlayer between the diamond particles and the quartz at the surface of the filter substrate. The colour change was not reversed following continued washing.

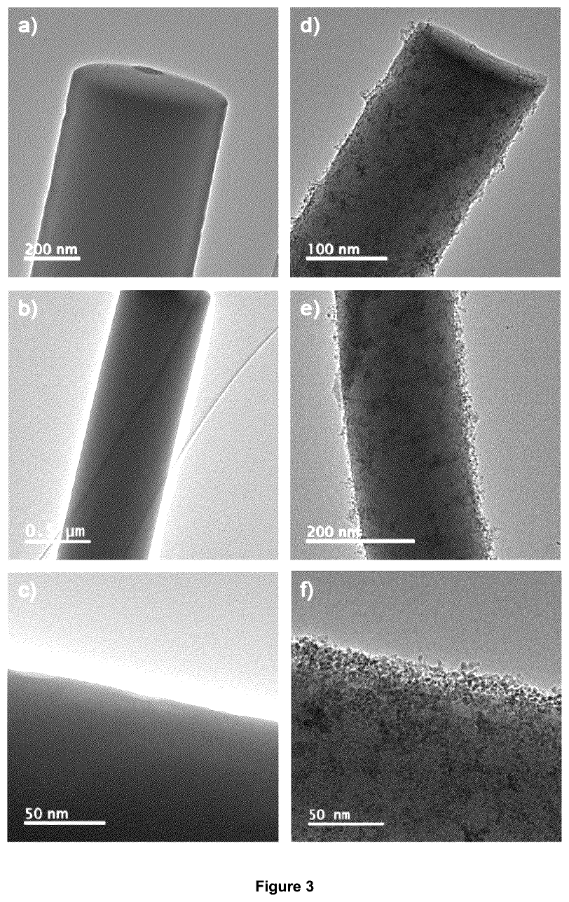

A scanning electron microscopy (SEM) image of the diamond-coated filter element is shown in FIG. 2. At this magnification, diamond nanoparticles adhered to the filter substrate's surface cannot be resolved. The morphology of the wool like mesh of quartz fibres, however, can be seen; each fibre is between 0.1-1 μm in diameter. The quartz fibre maintains its morphology upon coating with diamond nanoparticles and annealing at 500° C.

The fibres of the filter element were found to be in the sub-micron range (i.e. they are nanofibers). The filter element may therefore be referred to as a nanodiamond-coated quartz nanofibre (ND-QNF) membrane or nanodiamond-coated membrane. The filter substrate may be referred to as a quartz nanofibre (QNF) membrane or a quartz nanofibre support membrane.

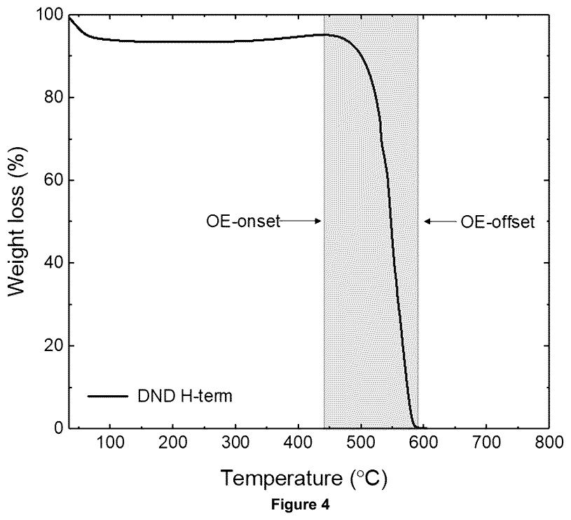

FIG. 3 shows transmission electron microscopy (TEM) images of the filter substrate (i.e. before coating) and the filter element (i.e. after dip-coating with a diamond nanoparticle colloid). The uncoated filter substrate exhibits a smooth and uninterrupted surface structure, as seen in FIGS. 3a)-c). The filter element shown in FIG. 3 was prepared by dip-coating the substrate in a 3.2 mg mL⁻¹ diamond nanoparticle colloid. The filter element is shown in FIGS. 3d)-f). The filter element displays a relatively uniform distribution of 5 nm diamond nanoparticles over the quartz fibre surface. A small degree of particle aggregation is also observed, but this is unlikely to affect the flow rate of the filter element.

### Filter Coating

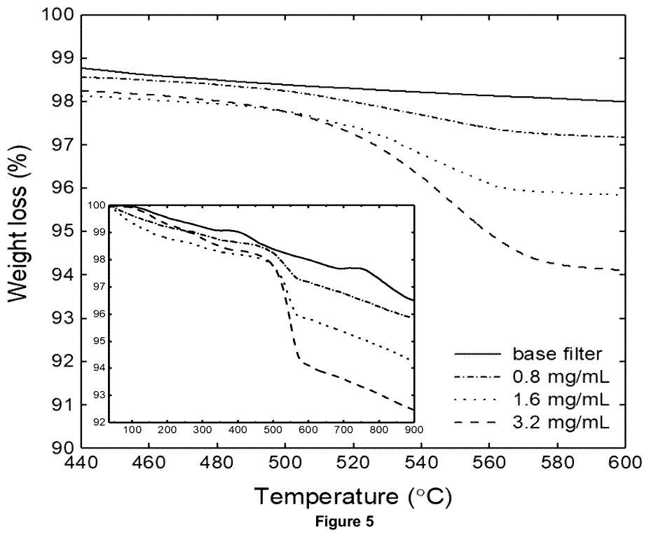

Thermogravimetric analysis (TGA) data is presented in FIGS. 4 to 6. FIG. 4 shows a TGA curve for hydrogen-terminated detonation nanodiamond powder (DND H-term), which was used to produce the diamond colloids for dip-coating. Its TGA curve may be split into four distinct temperature regimes. Between 35° C. and 100° C., a small decrease in sample mass of approx. 5% occurs, as water is desorbed from the diamond powder. Between 100° C. and 300° C., the sample mass remains constant. In the third regime, 300° C. to 440° C., the sample experiences an increase in mass as the diamond surface is oxidised; atomically lighter carbon-hydrogen bonding is replaced by the heavier carbon-oxygen bonds. Diamond is oxidatively etched at temperatures above 440° C., and the sample mass falls sharply. This occurs until the sample is completely etched away, at 590° C. In FIG. 4a), the etch temperature regime is shaded, and the oxidative etching onset (OE-onset) and offset (OE-offset) are marked.

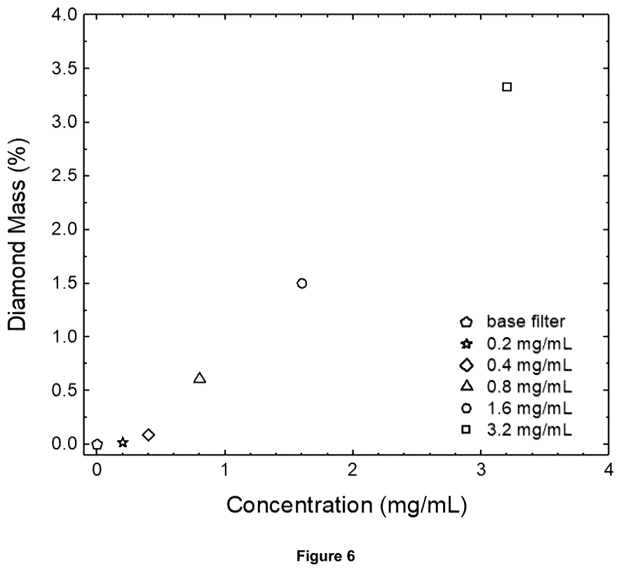

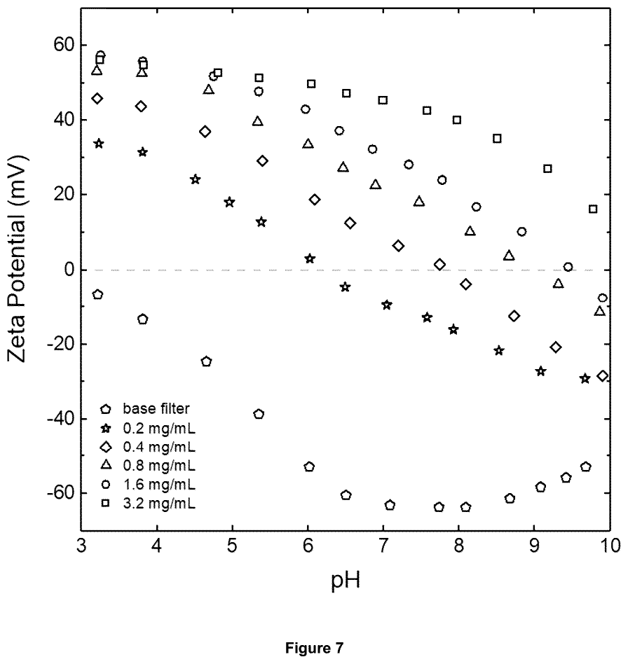

TGA curves for diamond-coated filters and an uncoated base filter element, are shown in FIG. 5, across the temperature range of the oxidative etch (inset is the full TGA temperature range). The plot is convoluted somewhat by non-diamond organic residue that burn off as the temperature is ramped. These residues account for a 0.75% reduction in filter mass between 440° C. and 590° C. Nevertheless, diamond coated filter samples clearly exhibit the characteristic drop in mass expected for diamond nanoparticles in this temperature regime. The mass loss per filter scales linearly with the concentration of colloid used to coat each filter: see FIG. 6. At most, following dip-coating with a 3.2 mg mL⁻¹ diamond colloid, and discounting mass loss from organics mentioned previously, the coated filter is 3.3% diamond by mass. Interestingly, we observe a sharper temperature regime for diamond etching on the filter, compared to that of the DND H-term (FIG. 4a). This is likely attributed to a smaller size distribution of diamond nanoparticles on the filter surface, compared to the DND H-term sample. The diamond powder (DND H-term), which has not been treated specifically to produce a monodisperse sample, likely possesses larger diamond particles as well as large agglomerates. These take longer to etch due to their smaller surface area:volume ratio.

### Filter Charging Behaviour

Zeta potential measurements are a reliable way of determining the sign and magnitude of a material's surface charge. In the ‘permeation mode’ set up, the flow-through geometry of the Surpass 3 electrokinetic analyser is in effect a small-scale model of the filter element in operation. To be able to filter effectively based on electrostatic forces, the filter element must possess a zeta potential of opposite charge to the target entity. In this case, the diamond coated filter element targets negatively charged entities, such as viruses or acid dyes, and must therefore exhibit a positive surface charge. The stronger the positive charge, the more effective the filter element will be. The filter should also maintain a positive zeta potential across a wide pH range, so as to be useful across a variety of water conditions.

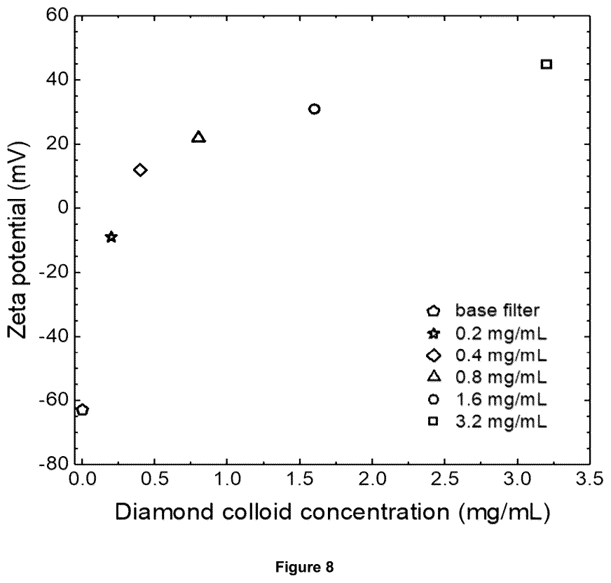

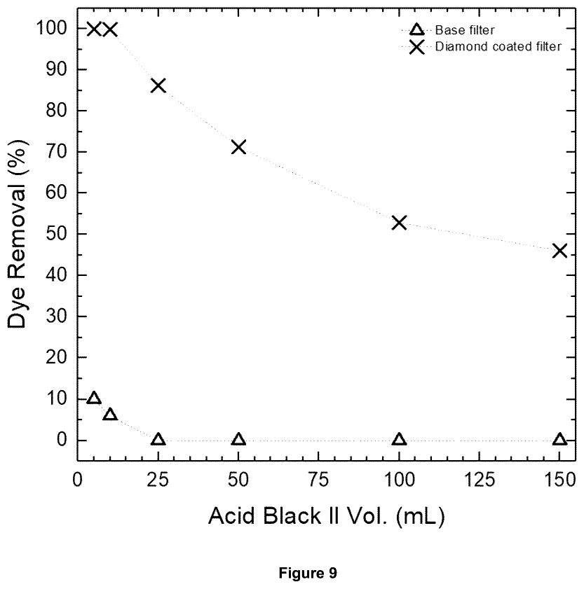

In FIGS. 7 and 8, filter element zeta potential is plotted as a function of pH. The filter element displays a negative zeta potential across the measured pH range. It exhibits an isoelectric point (pH_{IEP})<3 and a zeta potential value of −65 mV at pH 7. A considerable shift in the zeta potential relative to the filter substrate would indicate an effective shielding of the quartz surface of the filter substrate by the diamond coating. The diamond-coated filter elements are shifted to positive zeta potentials as the oxygen-based functionalities at the quartz surface are screened. Zeta potential values continue to increase as more diamond is loaded onto the filter substrates in the coating process. Under the most concentrated diamond colloid used, the pH_{IEP} is estimated to lie between pH 10-11, and at pH 7 exhibits a zeta potential of +45 mV. A requirement of the USEPA is that for a virus filter to be usable, it must remove viruses up to pH 9. The positive zeta potential for the diamond-coated filters following coating with 0.8 mg mL⁻¹ colloid concentrations and above, show this ability.

Whilst TGA data suggests a linear relationship between colloid concentration and diamond coated onto the filter elements, this does not relate to a linear increase in zeta potential. FIG. 8 describes the relationship between diamond colloid concentration and the zeta potential of the filter elements at pH 7. The plot suggests a maximum zeta potential, above which any increase in the amount of diamond coated onto the filter substrate will have no effect on zeta potential. This can be understood if we consider the functional group density of the filter surface. Complete protonation of the surface groups is inhibited above a certain point, by the electrostatic repulsion between neighbouring groups which makes protonation energetically unfavourable. Notwithstanding, an increase in the amount of diamond on the filter substrate does provide greater surface coverage, shielding any acidic groups on the quartz, and is the reason for the high pH_{IEP} of the most heavily coated filter elements.

### Depth Filtration Experiments

Coated filters (2.4 mg.mL⁻¹ coating solution) and base filter elements were challenged with increasing volumes of Acid Black II solution (10 mg.L⁻¹).

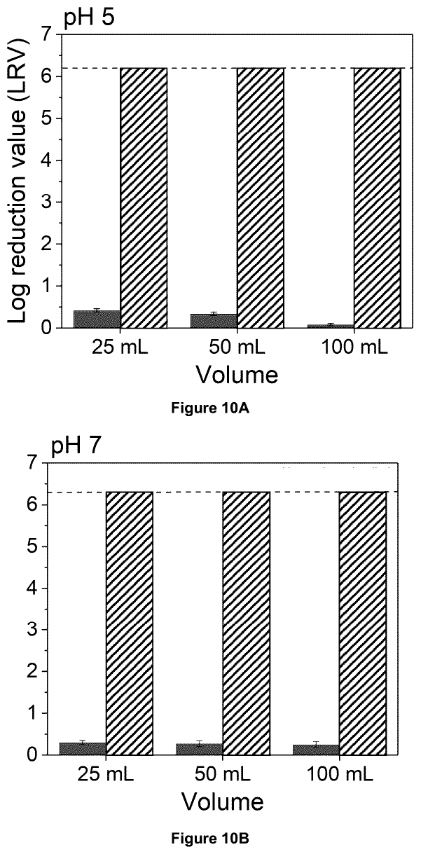

FIG. 9 displays a plot of the removal efficiency of Acid Black II dye as a function of total volume of dye solution filtered. 10 stacked filter elements of the invention, of thickness 430 μm and diameter 14 mm, and of the uncoated filter substrate (i.e. “base filter element”) were used in testing.

At volumes up to 10 mL, the base filter element removes no more than 10% of the dye. At volumes greater than 10 mL, there is no observable effect of the base filter element on the concentration of dye in solution.

Filtration efficiency is substantially improved when using diamond-coated filter elements. 100% efficiency in dye removal is observed for volumes up to 10 mL. The efficiency of the coated filters slowly declines until at 150 mL of filtered dye solution, just under 50% of the dye is filtered from solution. At this stage, the diamond-coated filters have filtered 250× their volume in dye solution.

### Example 2

### Filtration of Virus-Like Challenge Particles

Retention performance was evaluated for a non-pathogenic virus-like challenge particle, the MS2 coliphage; a bacteriophage with a diameter of roughly 26 nm and an isoelectric point of 3.9.

MS2 bacteriophage ATCC 15597-B1 was propagated at 37 ° C. overnight in 10 mL of sterile tryptone soya broth with the host bacterium Escherichia coli ATCC 15597. Following propagation, the suspension was centrifuged to 3000 g for 10 min, whereafter the supernatant was filtered by passing through a 0.2 μm cellulose acetate filter. The phage suspension was added to a 1×10⁻³ M NaCl solution to a phage concentration level on the order of 10⁷ plaque-forming units per litre (pfu/L). pH changes were induced in the feed water by the additions of 0.1 M NaOH and 0.1 M HCl solutions.

Volumes of phage containing feed water containing 10⁷ plaque forming units per litre (pfu/L) were flowed through either stacks of ten quartz nanofibre membranes (QNF membranes) or nanodiamond-coated quartz nanofibre membranes (ND-QNF membranes) discs. Each stack of ten membranes was supported between two perforated support disks. Filter elements (i.e. ND-QNF membranes) were prepared as in Example 1. Dimensions for the membrane stack were: 14 mm diameter, 1350 μm cumulative thickness, 0.66 cm³ total membrane stack volume. Pressures between 250 mbar and 500 mbar were applied to encourage feed water flow through the membrane stack.

100 μL samples were taken from both the feed water and permeate. Dilutions of the samples were prepared by adding SM buffer. 100 μL samples of diluted phage was added to 100 μL of the host bacterial strain E. coli ATCC 15597 (concentration of 5×10⁷ cfu/mL), and then mixed with 5 mL of 65% nutrient agar containing 500 μM CaCl. The nutrient agar, maintained at 45° C. by water bath, was then poured over a tryptone soya agar plate and left to solidify at room temperature for 30 minutes. Agar plates were finally inverted and placed in an incubator at 37° C. for 16-20 hours.

Permeate samples was assayed for three different pH values, and the retention of the membrane was calculated in terms of the log reduction value (LRV), given by Equation (1), where N_{feed} is the total number of viable microorganisms in the feed water, and Nₚₑᵣₘₑₐₜₑ is the total number of viable microorganisms in the permeate.

$$L R V = {log}_{10} \frac{{N}_{f e e d}}{{N}_{permeate}} \qquad ( 1 )$$

Pfu visible on the agar plates were counted and compared with those of the feed assay to determine the log reduction value. The statistical significance of data sets was evaluated with GraphPad PRISM® (version 8.1.1) using a two-way Analysis of Variance (ANOVA) with post-hoc Tukey Test. All experiments were performed in three independent biological replicates.

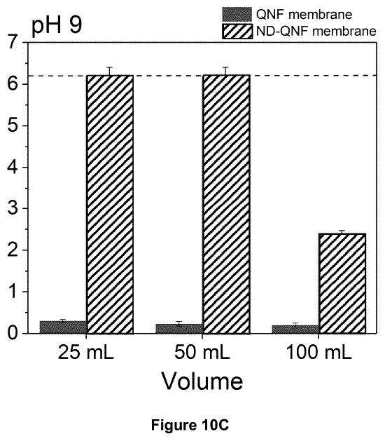

Data for the MS2 bacteriophage is shown in FIGS. 10A to 10C (for pH 5, 7 and 9 respectively). The QNF membrane shows poor retention of the bacteriophage, less than 0.5 LRV across all of the measured feed volumes and pH values. The ND-QNF membrane (represented by the hatched histograms in FIGS. 10A to 10C) displays 6.3 LRV (>99.9999%) at the three pH values measured. The LRV declined for large volumes of feed water at pH 9 when passing through the ND-QNF membrane stack. Since retention is proportional to the electrostatic interactions that lead to adsorption, the decline in retention is attributed to a lower membrane zeta potential at higher pH values, limiting the total retention capacity of the membrane. On occasions where the upper detection limit was reached (represented by the dashed line in FIGS. 10A to 10C), the true LRV is unknown, since no viable bacteriophage were counted on the assay plates, the LRV could be far greater. Nevertheless, ND-QNF membranes exhibited at least at 6.3 LRV; the results were found to be statistically significantly by two-way Analysis of Variance with post-hoc Tukey Test (ANOVA, Tukey; p<0.0001), for all pH value tested.

1. A filter element for filtering a fluid, wherein the filter element comprises diamond particles fixed to a filter substrate.

2. The filter element according to claim 1, wherein the diamond nanoparticles are 5 fixed to the filter substrate by a carbide.

3. The filter element according to claim 1 or claim 2, wherein the diamond particles have a mean particle diameter of ≤500 μm.

4. The filter element according to any one of the preceding claims, wherein the diamond particles are diamond nanoparticles, which have a diameter of less than 1 μm. 10 5. The filter element according to any one of the preceding claims, wherein the diamond particles have a zeta-potential greater than 0 mV at pH values of 3 to 7.

6. The filter element according to any one of the preceding claims, wherein the diamond particles have surfaces terminated with hydrogen atoms.

7. The filter element according to any one of the preceding claims, wherein the filter substrate is porous.

8. The filter element according to any one of the preceding claims, wherein the filter substrate has a surface layer comprising a carbide-forming compound.

9. The filter element according to any one of the preceding claims, wherein the filter substrate comprises a carbide-forming compound is selected from an oxide of silicon, an oxide of boron, an oxide of aluminium and an oxide of cerium.

10. The filter element according to claim 8 or claim 9, wherein the carbide-forming compound comprises an oxide of silicon, which comprises silica, silicate or an aluminium silicate.

11. A method of manufacturing a filter element, preferably a filter element as defined in any one of claims 1 to 10, wherein the method comprises:
applying diamond particles to a surface of a filter substrate; and then
fixing the diamond particles to the surface of the filter substrate.

12. The method according to claim 11, wherein the filter substrate has a surface layer comprising a carbide-forming compound, and the step of fixing the diamond particles to the surface of the filter substrate is by heating the diamond particles on a surface layer of the filter substrate, preferably to form a carbide bond between the diamond particles and the filter substrate.

13. The method according to claim 12, wherein the heating of the diamond particles on the surface layer of the filter substrate is at a temperature of 450° C. to 900° C.

14. The method according to any one of claims 11 to 13, wherein the step of applying diamond particles to a surface of a filter substrate is by coating the surface of the filter substrate with a liquid dispersion of diamond nanoparticles, preferably a colloidal dispersion of the diamond nanoparticles.

15. The method according to any one of claims 11 to 14, wherein the diamond particles are hydrogen-terminated diamond particles.

16. A filtration device for filtering a fluid, wherein the filtration device comprises:
a filter element as defined in any one of claims 1 to 10 or as obtained from the method of any one of claims 11 to 15; and
a housing comprising the filter element.

17. The filtration device of claim 16, which is a respirator.

18. A method of filtering a fluid comprising contacting the fluid with a filter element as defined in any one of claims 1 to 10.

19. Use of a filter element as defined in any one of claims 1 to 10 in the filtration of a fluid.

20. The method according to claim 18 or the use according to claim 19, wherein the fluid is a liquid.

21. The method according to claim 18 or the use according to claim 19, wherein the fluid is a gas, optionally a gas comprising a vapour.
